(19) United States
(12) Patent Application Publication
(10) Pub. No.: US 2016/0355752 A1
(43) Pub. Date: Dec. 8, 2016

(54) COMPACTED LIQUID LAUNDRY DETERGENT COMPOSITION

(71) Applicant: The Procter & Gamble Company, Cincinnati, OH (US)

(72) Inventors: Philip Frank SOUTER, Northumberland (GB); Alan Thomas BROOKER, Newcastle upon Tyne (GB); Nigel Patrick SOMERVILLE-ROBERTS, Newcastle upon Tyne (GB); Dan XU, Newcastle upon Tyne (GB); Jeremie Robert Marcel GUMMEL, Newcastle upon Tyne (GB)

(21) Appl. No.: 15/170,964

(22) Filed: Jun. 2, 2016

(30) Foreign Application Priority Data
Jun. 5, 2015 (EP) 15170779.1

(51) Int. Cl. C11D 1/12; C11D 17/04; C11D 3/20; C11D 1/66; C11D 3/50; C11D 3/30

(52) U.S. Cl. CPC C11D 1/12; C11D 3/50; C11D 3/30; C11D 3/2068; C11D 3/2044; C11D 1/66; C11D 17/043; C11D 17/045

(57) ABSTRACT

A liquid laundry detergent composition that includes: a non-amine neutralized linear alkylbenzene sulphonate, a non-amine neutralized alkyl sulphate or a mixture thereof; a non-ionic surfactant; an alcohol; a hydroxyl-containing amine compound; an adjunct ingredient; water.

### FIELD OF THE INVENTION

The present invention is to the field of liquid laundry detergent compositions and their methods of use.

### BACKGROUND OF THE INVENTION

Liquid laundry detergent compositions with low equilibrium relative humidities have the advantage of being less susceptible to microbial contamination. There is also a trend towards so called compacted liquids that minimise the presence of unnecessary ‘filler’ liquids such as water. Such compositions are more environmentally friendly as less unnecessary material needs to be transported, so reducing the environmental impact of such transport operations.

However, such compacted composition can often have high viscosities due to the high relative concentration of the cleaning materials such as anionic surfactants. Traditionally, hydroxyl-containing amines have been used in such compositions to ensure consumer acceptable viscosity of the liquid laundry detergent composition. Also, acceptable viscosity is required to allow processability of the composition during manufacture. The hydroxyl-containing amines are often used as neutralising agents for the anionic detergent surfactants such as linear alkylbenzene sulphonate.

However, there is now a desire to reduce the overall level of such hydroxyl-containing amines.

Reduction in the level of the hydroxyl-containing amines of known low relative humidity laundry detergent compositions can result in high viscosity of the composition which negatively impacts the ability of the consumer to accurately pour and dose the composition. Also, processability of the composition is impacted as it is difficult to handle such viscous compositions during manufacture.

Thus, there is a need in the art for low relative humidity liquid laundry detergent compositions containing lower levels of hydroxyl-containing amine compounds, but which exhibit consumer acceptable and/or process acceptable viscosities.

It has been surprisingly found that the above problems are overcome by the specific formulation space of the present invention. The formulation space described below can provide a liquid composition having a low relative humidity and comprising lower levels of hydroxyl-containing amine compounds but which has acceptable viscosity.

### SUMMARY OF THE INVENTION

The present disclosure relates to a liquid laundry detergent composition comprising:
From 10% to 50% by weight of the composition of a non-amine neutralized linear alkylbenzene sulphonate, a non-amine neutralized alkyl sulphate or a mixture thereof;
From 0% to 25% by weight of the composition of a non-ionic surfactant;
From 5% to 40% by weight of the composition of an alcohol having a molecular weight of between 20 and 400 and an eRH of between 50% and 80% at 20° C. as measured via the alcohol eRH test described herein;
Less than 5% by weight of the composition of a hydroxyl-containing amine compound;
From 20% to 40% by weight of the composition of an adjunct ingredient;
From 0.5% to 15% by weight of the composition of water.

The present disclosure further relates to a liquid laundry detergent composition comprising:
From 10% to 50% by weight of the composition of a non-amine neutralized linear alkylbenzene sulphonate, a non-amine neutralized alkyl sulphate or a mixture thereof;
From 0% to 25% by weight of the composition of a non-ionic surfactant;
From 5% to 40% by weight of the composition of an alcohol selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof, preferably the solvent is selected from the group comprising 1,2 propanediol, dipropylene glycol, polypropylene glycol, 2,3-butane diol, dipropylene glycol n-butyl ether and mixtures thereof;
Less than 5% by weight of the composition of a hydroxyl-containing amine compound;
From 20% to 40% by weight of the composition of an adjunct ingredient;
From 0.5% to 15% by weight of the composition of water.

### DETAILED DESCRIPTION OF THE INVENTION

### Liquid Laundry Detergent Composition

The present invention is to a liquid laundry detergent composition. The term ‘liquid’ encompasses aqueous compositions, non-aqueous compositions, gels, pastes, dispersions and the like. By laundry detergent composition, we herein mean a composition that can be used in a laundry wash and/or rinse operation. A laundry detergent composition can also be a laundry pre-treatment composition.

Preferably, the liquid laundry detergent composition has a viscosity of between 300 mPa·s and 700 mPa·s, more preferably between 350 mPa·s and 600 mPa·s at a shear rate of 1000 s⁻¹. An exemplary method for measuring viscosity is to use a Rheometer DHR1 from TA instruments using a gap of 1000 μm at 20° C. as according to the manufacturer's instructions.

The liquid laundry detergent composition may be present in a water-soluble unit dose article. In such an embodiment, the water-soluble unit dose article comprises at least one water-soluble film shaped such that the unit-dose article comprises at least one internal compartment surrounded by the water-soluble film. The at least one compartment comprises the liquid laundry detergent composition. The water-soluble film is sealed such that the liquid laundry detergent composition does not leak out of the compartment during storage. However, upon addition of the water-soluble unit dose article to water, the water-soluble film dissolves and releases the contents of the internal compartment into the wash liquor. The water-soluble unit dose article will be described in more detail below.

The liquid laundry detergent composition comprises from 10% to 50% by weight of the composition of a non-amine neutralized linear alkylbenzene sulphonate, a non-amine neutralized alkyl sulphate or a mixture thereof. Suitable non-amine neutralized linear alkylbenzene sulphonates and non-amine neutralized alkyl sulphate are described in more detail below.

The liquid laundry detergent composition comprises from 0% to 25% by weight of the composition of a non-ionic surfactant. Suitable non-ionic surfactants are detailed below.

The liquid laundry detergent composition comprises from 5% to 40% by weight of the composition of an alcohol having a molecular weight of between 20 and 400 and an eRH of between 50% and 80% at 20° C. as measured via the alcohol eRH test described below. Suitable alcohols are described in more detail below.

The liquid laundry detergent composition comprises less than 5% by weight of the composition of a hydroxyl-containing amine compound. Suitable amines are described in more detail below.

The liquid laundry detergent composition comprises from 0.5% to 15% by weight of the composition of water.

The liquid laundry detergent composition may comprise from 15% to 50% by weight of the composition of anionic surfactant. The anionic surfactant may be amine or non-amine neutralized. The anionic surfactant may comprise amine-neutralised alkyl sulphate, amine-neutralised ethoxylated alkyl sulphate, amine-neutralised linear alkylbenzene sulphonate, non-amine neutralized alkyl sulphate, non-amine neutralized ethoxylated alkyl sulphate, non-amine neutralized linear alkylbenzene sulphonate or a mixture.

The liquid laundry detergent composition comprises from 20% to 40% by weight of the composition of an adjunct ingredient. Suitable adjunct ingredients are described below.

The liquid laundry detergent composition may comprise a perfume raw material, wherein the perfume raw material is preferably selected from aldehydes, ketones or a mixture thereof.

Furthermore, removal of the hydroxyl-containing amine can cause the formulation to phase split (i.e. at least two visibly distinct phases can be seen). The present invention provides the additional benefit of providing a composition having a low relative humidity and lower levels of hydroxyl-containing amine compounds, whilst minimising phase splitting.

### Non-Amine Neutralized Surfactant

The liquid laundry detergent composition comprises from 10% to 50% by weight of the composition of a non-amine neutralized linear alkylbenzene sulphonate a non-amine neutralized alkyl sulphate and a mixture thereof. The linear alkylbenzene sulphonate, alkyl sulphate or mixture thereof may be present in the form of a solid dispersed with the liquid laundry detergent composition. By ‘solid’ we herein mean particulate, crystal, liquid lamellar crystal and mixtures thereof. Particles may include spray-dried, agglomerate, extrudates or a mixture thereof. Preferably the linear alkylbenzene sulphonate, alkyl sulphate or mixture thereof, is in lamellar liquid crystal form. By ‘lamellar liquid crystal’ we herein mean the system being in a state where the surfactant molecules are organised in stacks of bilayers of surfactant in the melted state separated by thin layers of solvent. This structure has both liquid properties in term of flowability as well as solid properties in term of being structured. The structure is characterised by its d-spacing, the sum of the bilayer thickness and the solvent layer between sheets. The repetition and periodicity of this structure yields to sharp x-ray diffraction peaks characteristic of crystal phases.

The liquid laundry detergent composition may comprise from 15% to 30% by weight of the laundry detergent composition of non-amine neutralised linear alkylbenzene sulphonate, a non-amine neutralized alkyl sulphate or a mixture thereof. The liquid laundry detergent composition may comprise from 15% to 50%, or even from 15% to 30% by weight of the laundry detergent composition of lamellar liquid crystal linear alkylbenzene sulphonat, lamellar liquid crystal non-amine neutralized alkyl sulphate or a mixture thereof.

Non-amine neutralized linear alkylbenzene sulphonates are those in which the linear alkylbenzene sulphonic acid is neutralized to the correspond linear alkylbenzene sulphonate salt using a neutralizing material other than an amine. Non-limiting examples of such neutralizing groups include sodium, potassium, magnesium and mixtures thereof. The non-amine neutralized linear alkylbenzene sulphonate may be a sodium linear alkylbenzene sulphonate, a potassium alkylbenzene sulphonate, a magnesium alkylbenzene sulphonate or a mixture thereof.

The non-amine neutralised linear alkylbenzene sulphonate may be a C₁₀-C₁₆ linear alkylbenzene sulphonate or a C₁₁-C₁₄ linear alkylbenzene sulphonate or a mixture thereof.

Exemplary linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear. Alkyl benzene sulfonates are well known in the art. Especially useful are the sodium, potassium and magnesium linear straight chain alkylbenzene sulfonates in which the average number of carbon atoms in the alkyl group is from about 11 to 14.

The liquid laundry detergent composition may comprise an amine-neutralised linear alkylbenzene sulphonate. Preferably, the liquid laundry detergent composition comprises less than 10%, or even less than 5%, or even less than 3% by weight of the liquid laundry detergent composition of an amine-neutralised linear alkylbenzene sulphonate.

The liquid laundry detergent composition may comprise a non-amine neutralized linear alkylbenzene sulphonate and an amine neutralized linear alkylbenzene sulphonate. The liquid laundry detergent composition may comprise between 10% and 30% by weight of the composition of a non-amine neutralized linear alkylbenzene sulphonate, preferably alkaline earth metal non-amine neutralized linear alkylbenzene sulphonate and less than 10%, or even less than 5%, or even less than 3% by weight of the liquid laundry detergent composition of an amine-neutralised linear alkylbenzene sulphonate, preferably monethanolamine linear alkylbenzene sulphonate, triethanolamine linear alkylbenzene sulphonate or a mixture thereof.

The non-amine neutralized alkyl sulphate anionic surfactant may be present in the form of a solid dispersed within the liquid laundry detergent composition. By ‘solid’ we herein mean particulate, crystal, lamellar liquid crystal and mixtures thereof.

Non-amine neutralized alkyl sulphate anionic surfactants are those in which the surfactant acid is neutralized to the correspond salt using a neutralizing material other than an amine. Non-limiting examples of such neutralizing groups include sodium, potassium, magnesium and mixtures thereof. The non-amine neutralized alkyl sulphate anionic surfactant may be a sodium alkyl sulphate anionic surfactant, a potassium alkyl sulphate anionic surfactant, a magnesium alkyl sulphate anionic surfactant or a mixture thereof.

The alkyl sulphate anionic surfactant may comprise ethoxylated alkyl sulphate or non-ethoxylated alkyl sulphate or a mixture thereof.

The non-amine neutralised alkyl sulphate anionic surfactant may comprise an ethoxylated non-amine neutralised alkyl sulphate anionic surfactant, preferably with an average degree of ethoxylation from 1 to 5, more preferably from 1 to 3. The ethoxylated non-amine neutralised alkyl sulphate anionic surfactant may have an average degree of ethoxylation of 1 or 3 or a mixture thereof, preferably the ethoxylated non-amine neutralised alkyl sulphate anionic surfactant has an average degree of ethoxylation of 1.

The non-amine neutralised alkyl sulphate anionic surfactant may comprise a non-ethoxylated alkyl sulphate and an ethoxylated alkyl sulphate wherein the average degree of ethoxylation of the ethoxylated alkyl sulphate is from 1 to 5, more preferably from 1 to 3, or a mixture thereof.

### Non-Ionic Surfactant

The liquid laundry detergent composition comprises from 0% to 25% by weight of the composition of a non-ionic surfactant.

The non-ionic surfactant may be a natural or synthetically derived non-ionic surfactant. Preferably, the non-ionic surfactant comprises a natural or synthetically derived fatty alcohol ethoxylate non-ionic surfactant. Preferred synthetically derived fatty alcohol ethoxylate non-ionic surfactant or those derived from the oxo-synthesis process, or so-called oxo-synethesised non-ionic surfactants. The composition may comprise from 0% to 30% or even from 0.1% to 25% by weight of the composition of fatty alcohol ethoxylate non-ionic surfactant.

The ethoxylated nonionic surfactant may be, e.g., primary and secondary alcohol ethoxylates, especially the C₈-C₂₀ aliphatic alcohols ethoxylated with an average of from 1 to 50 or even 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol.

The ethoxylated alcohol non-ionic surfactant can be, for example, a condensation product of from 3 to 8 mol of ethylene oxide with 1 mol of a primary alcohol having from 9 to 15 carbon atoms.

The non-ionic surfactant may comprise a fatty alcohol ethoxylate of formula R(EO)ₙ, wherein R represents an alkyl chain between 4 and 30 carbon atoms, (EO) represents one unit of ethylene oxide monomer and n has an average value between 0.5 and 20.

The composition may comprise other non-ionic surfactants, preferably natural or synthetic non-ionic surfactants.

### Alcohol

The composition comprises between 5% and 40%, or even between 5% and 20% or even between 5% and 15% by weight of the composition of an alcohol, wherein the alcohol has a molecular weight of between 20 and 400 and an equlibirum relative humidity (“eRH”) of between 50% and 80%, or even between 52% and 75% at 20° C. as measured via the alcohol eRH test.

The alcohol eRH test comprises the steps of preparing a solution of 80% alcohol in deionised water, followed by adding this to a calibrated Rotronic Hygrolab meter (in a plastic sample liner of 14 mm depth) at room temperature (20° C.+/−1° C.) and allowing this to equilibrate for 25 minutes, and finally measuring the eRH recorded. The volume of sample used was sufficient to fill the plastic sample liner.

By ‘alcohol’ we herein mean either a single compound or a mixture of compounds that when taken together collectively each have a molecular weight of between 20 and 400 and an overall eRH of the compound or mixture of between 50% and 80% at 20° C. as measured via the eRH test. Without wishing to be bound by theory, an alcohol is any compound comprising at least one OH unit, preferably polyols and diols, more preferably diols. Preferred diols included glycols.

Preferably, the alcohol may be selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof.

More preferably, the alcohol may be selected from the group comprising ethylene glycol, 1,2 propanediol, 2,3-butane diol, 1,3 butanediol, triethylene glycol, polyethylene glycol, glycerol formal dipropylene glycol, polypropylene glycol, dipropylene glycol n-butyl ether, and mixtures thereof.

Even more preferably the alcohol is selected from the group comprising 1,2 propanediol, dipropylene glycol, polypropylene glycol, 2,3-butane diol, dipropylene glycol n-butyl ether and mixtures thereof.

Most preferably the alcohol may be selected from the group comprising 1,2 propanediol, dipropylene glycol, polypropylene glycol, dipropylene glycol n-butyl ether and mixtures thereof.

### Amine

The detergent composition comprises less than 5% by weight of the composition of a hydroxyl-containing amine compound, or even from 0.1% to 5%, or even from 0.1% to 4% by weight of the composition of a hydroxyl-containing amine compound. By ‘hydroxyl-containing amine compound’ we herein mean a compound comprising an alcohol (OH) group and an amine group. The hydroxyl-containing amine compound may be selected from monoethanolamine, triethanolamine, diisopropanolamine, triisopropanolamine, Monoamino hexanol, 2-[(2-methoxyethyl) methylamino]-ethanol, Propanolamine, N-Methylethanolamine, diethanolamine, Monobutanol amine, Isobutanolamine, Monopentanol amine, 1-Amino-3-(2-methoxyethoxy)-2-propanol, 2-Methyl-4-(methylamino)-2-butanol, 6-amino-1-hexanol, Heptaminol, Isoetarine, Norepinephrine, Sphingosine, Phenylpropanolamine and mixtures thereof.

The hydroxyl-containing amine compound may be selected from the group comprising monoethanol amine, triethanolamine and mixtures thereof.

Preferably, the hydroxyl-containing amine compound has a molecular weight of less than 500, or even less than 250.

The detergent composition may comprise other amine containing compounds.

### Structurant

The composition of the present invention may comprises less than 2% by weight of the composition of a structurant. If a structurant is present, preferably the composition comprises from 0.05% to 2%, preferably from 0.1% to 1% by weight of a structurant. The structurant may be selected from non-polymeric or polymeric structurants. The structurant may be a non-polymeric structurant, preferably a crystallisable glyceride. The structurant may be a polymeric structurant, preferably a fibre based polymeric structurant, more preferably a cellulose fibre-based structurant. The structurant may be selected from crystallisable glyceride, cellulose-fibre based structurants, TiO₂, silica and mixtures thereof.

Suitable structurants are preferably ingredients which impart a sufficient yield stress or low shear viscosity to stabilize the liquid laundry detergent composition independently from, or extrinsic from, any structuring effect of the detersive surfactants of the composition. Preferably, they impart to the laundry detergent composition a high shear viscosity at 20 sec-1 at 21° C. of from 1 to 1500 cps and a viscosity at low shear (0.05 sec-1 at 21° C.) of greater than 5000 cps. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1-1 to 25-1 in 3 minutes time at 21° C.

The structurant may be a polymeric crystalline, hydroxy-functional structurant that comprises a crystallizable glyceride, preferably hydrogenated castor oil or “HCO”. HCO as used herein most generally can be any hydrogenated castor oil or derivative thereof, provided that it is capable of crystallizing in the non-polymeric crystalline, hydroxy-functional structurant premix. Castor oils may include glycerides, especially triglycerides, comprising C₁₀ to C₂₂ alkyl or alkenyl moieties which incorporate a hydroxyl group. Hydrogenation of castor oil, to make HCO, converts the double bonds which may be present in the starting oil as ricinoleyl moieties. As such, the ricinoleyl moieties are converted into saturated hydroxyalkyl moieties, e.g., hydroxystearyl. The HCO herein may be selected from: trihydroxystearin; dihydroxystearin; and mixtures thereof. The HCO may be processed in any suitable starting form, including, but not limited to those selected from solid, molten and mixtures thereof.

HCO of use in the present invention includes those that are commercially available. Non-limiting examples of commercially available HCO of use in the present invention include: THIXCIN® from Rheox, Inc.

The structurant may comprise a fibre-based structurant. The structurant may comprise a microfibrillated cellulose (MFC), which is a material composed of nanosized cellulose fibrils, typically having a high aspect ratio (ratio of length to cross dimension). Typical lateral dimensions are 1 to 100, or 5 to 20 nanometres, and longitudinal dimension is in a wide range from nanometres to several microns. For improved structuring, the microfibrillated cellulose preferably has an average aspect ratio (lid) of from 50 to 200,000, more preferably from 100 to 10,000. Microfibrillated cellulose can be derived from any suitable source, including bacterial cellulose, citrus fibers, and vegetables such as sugar beet, chicory root, potato, carrot, and the like.

The structurant may be selected from the group consisting of titanium dioxide, tin dioxide, any forms of modified TiO₂, TiO₂ or stannic oxide, bismuth oxychloride or bismuth oxychloride coated TiO₂, silica coated TiO₂ or metal oxide coated TiO₂ and mixtures thereof. Modified TiO₂ may comprise carbon modified TiO₂, metallic doped TiO₂ or mixtures thereof. Metallic doped TiO₂ may be selected from platinum doped TiO₂, Rhodium doped TiO₂.

The structurant may comprise silica. Those skilled in the art will know suitable silica materials to use. The silica may comprise fumed silica.

### Water and Equilibrium Relative Humidity

The liquid laundry detergent composition comprises between 0.5% and 15% by weight of the composition of water. The liquid laundry detergent composition may comprise between 0.5% and 12%, or even between 0.5% and 10% by weight of the composition of water.

The liquid laundry detergent composition may have an equilibrium relative humidity (“eRH”) of less than 65% at 20° C.

A preferred method for measuring the eRH of the composition is via the composition eRH test. The composition eRH test comprises the steps of adding a sample of the composition to a calibrated Rotronic Hygrolab meter (in a plastic sample liner of 14 mm depth) at room temperature (20° C.+/−1° C.) and allowing this to equilibrate for 25 minutes, and finally measuring the eRH recorded. The volume of sample used was sufficient to fill the plastic sample liner.

### Adjunct Ingredient

The liquid laundry detergent composition comprises between 20% and 40% by weight of the composition of an adjunct ingredient. The adjunct ingredient may be selected from the group comprising bleach, bleach catalyst, dye, hueing dye, cleaning polymers including alkoxylated polyamines and polyethyleneimines, soil release polymer, surfactant, solvent, dye transfer inhibitors, chelant, enzyme, perfume, encapsulated perfume, polycarboxylate polymers, cellulosic polymers, and mixtures thereof.

Hueing Dye: The liquid laundry detergent composition may comprise a hueing dye. The hueing dyes employed in the present laundry care compositions may comprise polymeric or non-polymeric dyes, pigments, or mixtures thereof. Preferably the hueing dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred.

The hueing dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

Chelant: The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein. Suitable chelants may be selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The laundry detergent composition may comprise ethylene diamine-N′N′-disuccinic acid or salt thereof. The ethylene diamine-N′N′-disuccinic acid may be in S,S enantiomeric form. The composition may comprise 4,5-dihydroxy-m-benzenedisulfonic acid disodium salt, glutamic acid-N,N-diacetic acid (GLDA) and/or salts thereof, 2-hydroxypyridine-1-oxide, Trilon P™ available from BASF, Ludwigshafen, Germany. Suitable chelants may also be calcium carbonate crystal growth inhibitors. Suitable calcium carbonate crystal growth inhibitors may be selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

### Water-Soluble Pouch

The liquid laundry detergent composition may be present in a water-soluble unit dose article. In such an embodiment, the water-soluble unit dose article comprises at least one water-soluble film shaped such that the unit-dose article comprises at least one internal compartment surrounded by the water-soluble film. The at least one compartment comprises the liquid laundry detergent composition. The water-soluble film is sealed such that the liquid laundry detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the composition according to the present invention may be comprised in at least one of the compartments. It may for example be comprised in just one compartment, or may be comprised in two compartments, or even in three compartments.

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3L beaker and 2L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

Of the total PVA resin content in the film described herein, the PVA resin can comprise about 30 to about 85 wt % of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000rpm.

### Method of Making

The liquid laundry detergent composition of the present invention may be made using any suitable manufacturing techniques known in the art. Those skilled in the art would know appropriate methods and equipment to make the composition according to the present invention.

HCO premix may be formed by melting HCO and adding into a small volume of a hot liquid laundry detergent composition wherein the composition does not comprise enzymes or perfume materials. The HCO premix is then added to other ingredients to form the liquid laundry detergent composition.

### Method of Use

The composition or unit dose article of the present invention can be added to a wash liquor to which laundry is already present, or to which laundry is added. It may be used in an washing machine operation and added directly to the drum or to the dispenser drawer. The washing machine may be an automatic or semi-automatic washing machine. It may be used in combination with other laundry detergent compositions such as fabric softeners or stain removers. It may be used as pre-treat composition on a stain prior to being added to a wash liquor.

### EXAMPLES

The viscosity of various compositions were compared. The following compositions were prepared;

TABLE 1

| | Compositions (wt %) | | |
|---|---|---|---|
| | A | B | C |
| water | 7.16 | 7.16 | 7.44 |
| Dipropylene glycol | 14.66 | 14.66 | 31.19 |
| 1,2-propanediol | | 10.00 | |
| Dipropylene glycol n-butyl ether | 9.80 | 9.80 | |
| Glycerol | 15.00 | 5.00 | 5.00 |
| Linear alkylbenzene sulphonate | | | 23.59 |
| neutralized with monoethanolamine | | | |
| Linear alkylbenzene sulphonate | 23.59 | 23.59 | |
| neutralized with sodium carbonate | | | |
| Ethoxylated polyethyleneimine | 2.16 | 2.16 | 2.16 |
| Alkyl sulphate with an average | | | 11.00 |
| degree of ethoxylation of 3, | | | |
| neutralized with monoethanolamine | | | |
| Alkyl sulphate with an average | 11.00 | 11.00 | |
| degree of ethoxylation of 3, | | | |
| neutralized with sodium carbonate | | | |
| HEDP | 1.81 | 1.81 | 1.81 |
| Amphiphilic graft copolymer | 2.72 | 2.72 | 2.72 |
| Brightener 49 | 0.24 | 0.24 | 0.24 |
| Soil release polymer commercially | 0.32 | 0.32 | 0.32 |
| available from Clariant as SRA-300 | | | |
| Carboxymethyl cellulose | 1.07 | 1.07 | 1.07 |
| Siloxane polymeric suds suppressor | 0.13 | 0.13 | 0.13 |
| Perfume | 2.68 | 2.68 | 2.68 |
| protease | 0.10 | 0.10 | 0.10 |
| TiO2 | 0.50 | 0.50 | 0.50 |
| palm kernel fatty acid | 3.26 | 3.26 | 3.26 |
| Guerbet alcohol non-ionic | 0.56 | 0.56 | 0.56 |
| surfactant commercially available | | | |
| from BASF as Lutensol XL100 | | | |
| minors | 2.36 | 2.36 | 2.77 |

The compositions were made by preparing a 1L beaker having an IKA Eurostar 200 mixer with 10 cm impeller. This was operated at 250 rpm. To the beaker with the roatating impellar, the solvent materials were added, followed by the surfactant materials. Once these had dispersed, the polymers and salts were added. The pH of the composition was adjusted using NaOH to approximately & (measured using a Sartorius PT-10 pH meter). Remaining ingredients were then added and mixed. All materials were weighed out using a Mettler Toledo PB3002-S balance.

Composition C comprised 6.25% by weight of composition C of monoethanolamine. Compositions A and B comprised no monoethanolamine.

The viscosity of the compositions were then measured using a Rheometer DHR1 from TA instruments using a gap of 1000 μm at 20° C. Samples were equilibrated for 1 min at 0.05 s⁻¹ followed by a measured flow curve from 0.05 s⁻¹ to 1200 s⁻¹ over 10 mins. Results for 0.05 s⁻¹ and 1000 s⁻¹ are shown in Table 2.

TABLE 2

| | 0.05 s−1 | 1000 s−1 |
|---|---|---|
| | mPa · s | mPa · s |
| A | 1560 | 870 |
| B | 1112 | 413 |
| C | 1310 | 315 |

Shear at 0.05 s⁻¹ corresponds to that experienced by the composition during pouring of the composition by the consumer. Shear at 1000 s⁻¹ corresponds to that experienced by the composition during manufacture.

Composition C which comprises 6.25% monoethanolamine shows an acceptable viscosity profile at low and high shear corresponding to consumer pouring shear and process dosing shear. However, when the monoethanolamine is removed in composition A (and correspondingly the surfactants are neutralized with sodium carbonate), there is an increase in viscosity to unacceptable levels.

Composition B corresponds to the present invention in which the monoethanolamine has been removed and the surfactants neutralized with sodium carbonate, but also 1,2-propandiol has been added. The viscosity returns to acceptable levels.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising:
from about 10% to about 50% by weight of the composition of a non-amine neutralized linear alkylbenzene sulphonate, a non-amine neutralized alkyl sulphate or a mixture thereof;
from about 0% to about 25% by weight of the composition of a non-ionic surfactant;
from about 5% to about 40% by weight of the composition of an alcohol having a molecular weight of between about 20 and about 400 and an eRH of between about 50% and about 80% at about 20° C. as measured via the alcohol eRH test described herein;
less than about 5% by weight of the composition of a hydroxyl-containing amine compound;
from about 20% to about 40% by weight of the composition of an adjunct ingredient;
from about 0.5% to about 15% by weight of the composition of water.

2. A liquid laundry detergent composition according to claim 1, comprising less than about 10% by weight of the composition of an amine-neutralised linear alkylbenzene sulphonate.

3. A liquid laundry detergent composition according to claim 1 comprising from about 15% to about 30% by weight of the composition of a non-amine neutralised linear alkylbenzene sulphonate, a non-amine neutralized alkyl sulphate or a mixture thereof.

4. A liquid laundry detergent composition according to claim 1 wherein the non-amine neutralised linear alkylbenzene sulphonate is a C₁₀-C₁₆ linear alkylbenzene sulphonate or C₁₁-C₁₄ linear alkylbenzene sulphonate or a mixture thereof.

5. A liquid laundry detergent composition according to claim 1 wherein the non-amine neutralised alkyl sulphate anionic surfactant comprise a non-ethoxylated alkyl sulphate and an ethoxylated alkyl sulphate wherein the average degree of ethoxylation of the ethoxylated alkyl sulphate is from about 1 to about 5.

6. A liquid laundry detergent composition according to claim 5 wherein the average degree of ethoxylation of the ethoxylated alkyl sulphate is from about 1 to about 3.

7. A liquid laundry detergent composition according to claim 6, wherein the average degree of ethoxylation is about 1.

8. A liquid laundry detergent composition according to claim 1 comprising sodium linear alkylbenzene sulphonate, potassium linear alkylbenzene sulphonate, magnesium linear alkylbenzene sulphonate sodium alkyl sulphate, potassium alkyl sulphate, magnesium alkyl sulphate or mixture thereof.

9. A liquid laundry detergent composition according to claim 1 comprising from about 15% to about 50% by weight of the composition of anionic surfactant.

10. A liquid laundry detergent composition according to claim 1 wherein the composition comprises from about 5% to about 20% by weight of the composition of the alcohol.

11. A liquid laundry detergent composition according to claim 1 wherein the hydroxyl-containing amine is selected from the group comprising monoethanol amine, triethanolamine and mixtures thereof.

12. A liquid laundry detergent composition according to claim 1 wherein the non-ionic surfactant comprises a fatty alcohol ethoxylated, an oxo-synthesised fatty alcohol ethoxylate or a mixture thereof.

13. A liquid laundry detergent composition according to claim 1 comprising a perfume raw material selected from aldehydes, ketones or a mixture thereof.

14. A liquid laundry detergent composition according to claim 1 comprising a structurant, wherein the structurant is selected from crystallisable glyceride, cellulose-fibre based structurants, TiO₂, silica and mixtures thereof.

15. A liquid laundry detergent composition according to claim 1 wherein the adjunct ingredient is selected from the group comprising bleach, bleach catalyst, dye, hueing dye, cleaning polymers including alkoxylated polyamines and polyethyleneimines, soil release polymer, surfactant, solvent, dye transfer inhibitors, chelant, enzyme, perfume, encapsulated perfume, polycarboxylate polymers, cellulosic polymers, and mixtures thereof.

16. A water-soluble unit dose article comprising a water-soluble film and a detergent composition according to claim 1.

17. The unit dose article according to claim 16 wherein the unit dose article comprises at least two compartments.

18. The unit dose article according to claim 17 comprising at least three compartments.

19. A liquid laundry detergent composition comprising:
from about 10% to about 50% by weight of the composition of a non-amine neutralized linear alkylbenzene sulphonate, a non-amine neutralized alkyl sulphate or a mixture thereof;
from about 0% to about 25% by weight of the composition of a non-ionic surfactant;
from about 5% to about 40% by weight of the composition of an alcohol selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof, preferably the solvent is selected from the group comprising 1,2 propanediol, dipropylene glycol, polypropylene glycol, 2,3-butane diol, dipropylene glycol n-butyl ether and mixtures thereof;
less than 5% by weight of the composition of a hydroxyl-containing amine compound;
from about 20% to about 40% by weight of the composition of an adjunct ingredient;
from about 0.5% to about 15% by weight of the composition of water.
